(19) United States
(12) Patent Application Publication
(10) Pub. No.: US 2025/0270849 A1
(43) Pub. Date: Aug. 28, 2025

(54) ELECTRONIC LOCK AND DRIVING METHOD OF ELECTRONIC LOCK

(71) Applicant: TAIWAN FU HSING INDUSTRIAL CO., LTD., Kaohsiung City (TW)

(72) Inventor: Shih-Min Lu, Kaohsiung City (TW)

(73) Assignee: TAIWAN FU HSING INDUSTRIAL CO., LTD., Kaohsiung City (TW)

(21) Appl. No.: 18/634,990

(22) Filed: Apr. 14, 2024

(30) Foreign Application Priority Data
Feb. 23, 2024 (TW) 113106557

(51) Int. Cl. E05B 47/00

(52) U.S. Cl. CPC E05B 47/0012; E05B 2047/0017; E05B 2047/002; E05B 2047/0053; E05B 2047/0067

(57) ABSTRACT

An electronic lock includes a motor, a transmission gear, a transmission shaft, a first sensor and a second sensor. The transmission gear is connected to the motor. The transmission gear has a first transmission structure and a first geometric structure. The transmission shaft is rotatably connected to the transmission gear. The transmission shaft has a second transmission structure and a second geometric structure. The first sensor is disposed with respect to the first geometric structure and senses a position of the transmission gear through the first geometric structure. The second sensor is disposed with respect to the second geometric structure and senses a position of the transmission shaft through the second geometric structure. The motor drives the transmission gear to rotate according to sensing results of the first and second sensors. The transmission gear drives the transmission shaft to rotate through the first and second transmission structures.

### BACKGROUND OF THE INVENTION

### 1. Field of the Invention

The invention relates to an electronic lock and, more particularly, to a driving method of an electronic lock.

### 2. Description of the Prior Art

In general, an electronic lock may be automatically controlled by a motor or manually controlled by a turnpiece. In the electronic lock, the motor and the turnpiece are respectively connected a bolt through a transmission mechanism. When a user turns the turnpiece to retract or extend the bolt, the motor will be driven in the reverse direction to generate reverse electromotive force, which will affect the stability of a power supply. Furthermore, the motor will also generate resistance to the rotation of the turnpiece, which will affect the operating feel of the user.

### SUMMARY OF THE INVENTION

The invention provides an electronic lock and a driving method of an electronic lock, so as to solve the aforesaid problems.

According to an embodiment of the invention, an electronic lock comprises a motor, a transmission gear, a transmission shaft, a first sensor and a second sensor. The transmission gear is connected to the motor. The transmission gear has a first transmission structure and a first geometric structure. The transmission shaft is rotatably connected to the transmission gear. The transmission shaft has a second transmission structure and a second geometric structure. The first sensor is disposed with respect to the first geometric structure. The first sensor senses a position of the transmission gear through the first geometric structure. The second sensor is disposed with respect to the second geometric structure. The second sensor senses a position of the transmission shaft through the second geometric structure. The motor drives the transmission gear to rotate according to sensing results of the first sensor and the second sensor, and the transmission gear drives the transmission shaft to rotate through the first transmission structure and the second transmission structure.

According to another embodiment of the invention, a driving method of the electronic lock comprises steps of the first sensor sensing a position of the transmission gear through the first geometric structure, and the second sensor sensing a position of the transmission shaft through the second geometric structure; the motor driving the transmission gear to rotate according to sensing results of the first sensor and the second sensor; and the transmission gear driving the transmission shaft to rotate through the first transmission structure and the second transmission structure, so as to lock or unlock the electronic lock.

As mentioned in the above, the motor of the electronic lock drives the transmission gear to rotate according to the sensing results of the first sensor and the second sensor. After the motor drives the transmission gear to rotate to unlock or lock the electronic lock, the motor will further drive the transmission gear to rotate in the reverse direction. When a user turns a turnpiece to unlock or lock the electronic lock, the motor will not be driven by the turnpiece. Accordingly, the stability of a power supply and the operating feel of the user will not be affected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating an electronic lock according to an embodiment of the invention.

FIG. 2 is a perspective view illustrating the inside of the electronic lock.

FIG. 3 is a perspective view illustrating a motor and a transmission gear.

FIG. 4 is a perspective view illustrating the transmission gear and a first sensor.

FIG. 5 is a perspective view illustrating a transmission shaft, a second sensor and a turnpiece.

FIG. 6 is an exploded view illustrating the electronic lock, a bolt and a lock cylinder.

FIG. 7 is a perspective view illustrating a door equipped with the turnpiece, the bolt and the lock cylinder.

FIG. 8 is a front view illustrating the electronic lock being locked.

FIG. 9 is a front view illustrating the electronic lock being unlocked.

FIG. 10 is another front view illustrating the electronic lock being unlocked.

FIG. 11 is another front view illustrating the electronic lock being locked.

### DETAILED DESCRIPTION

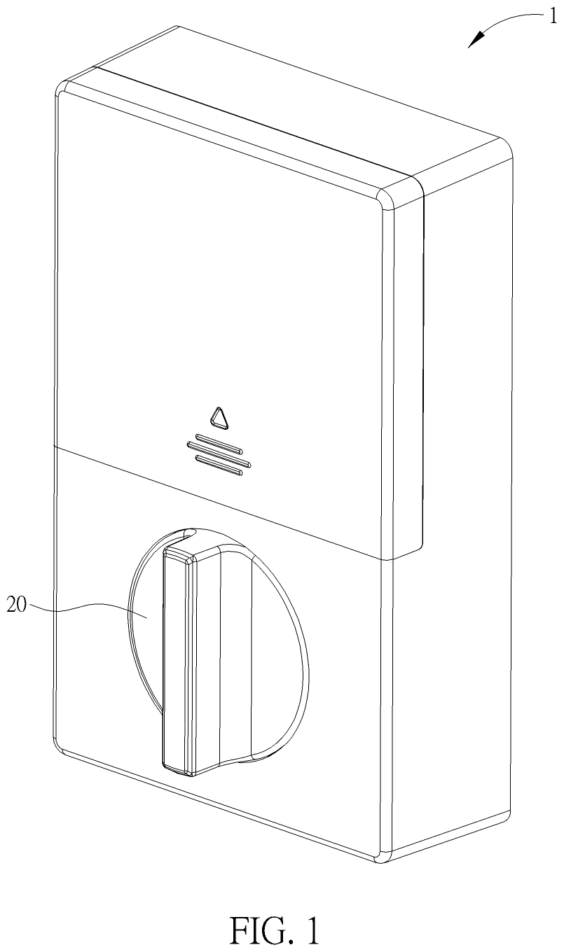

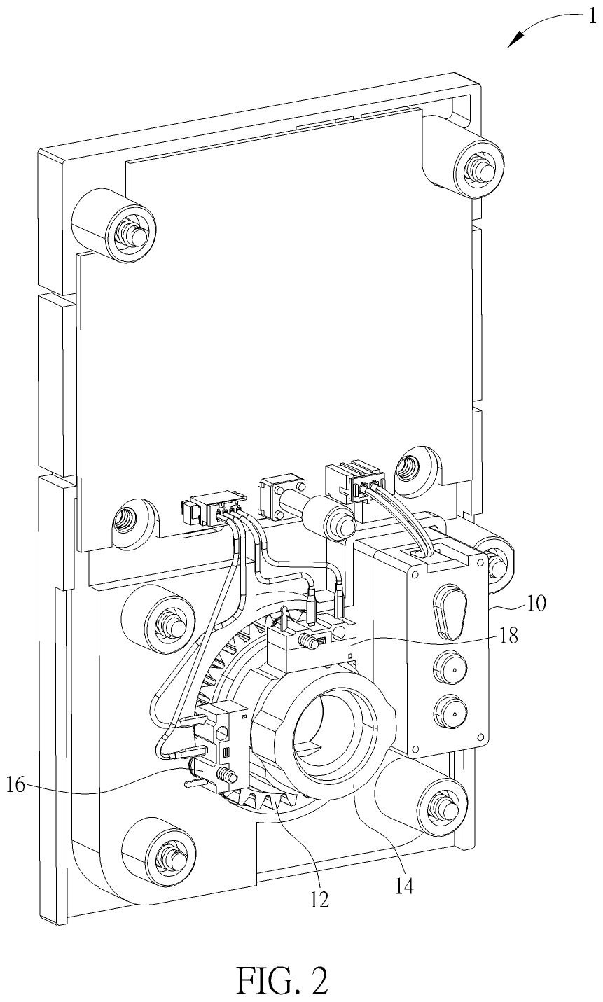

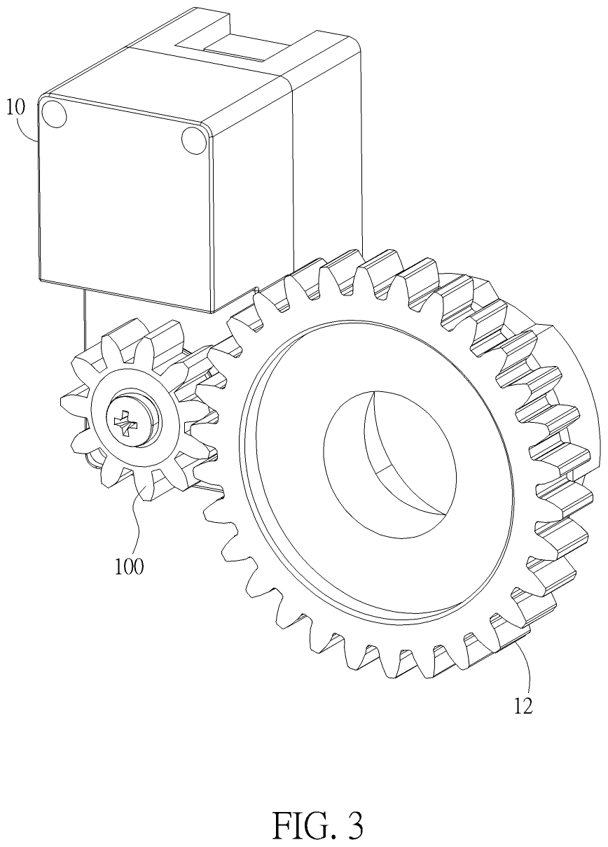

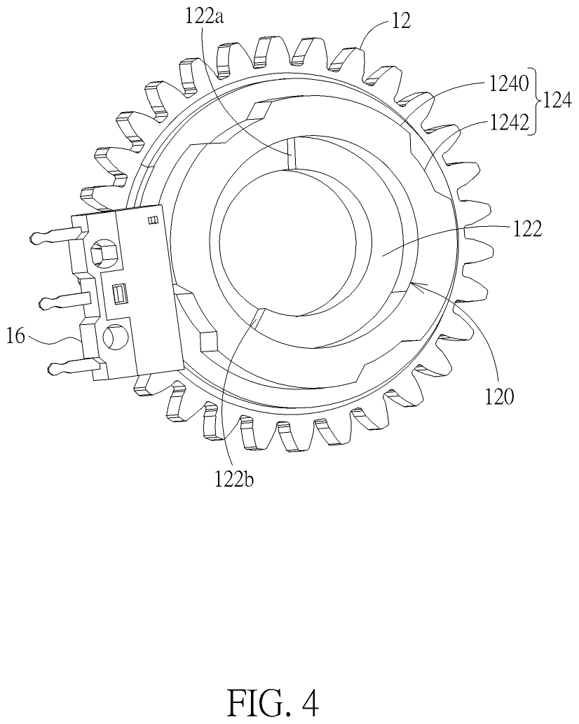

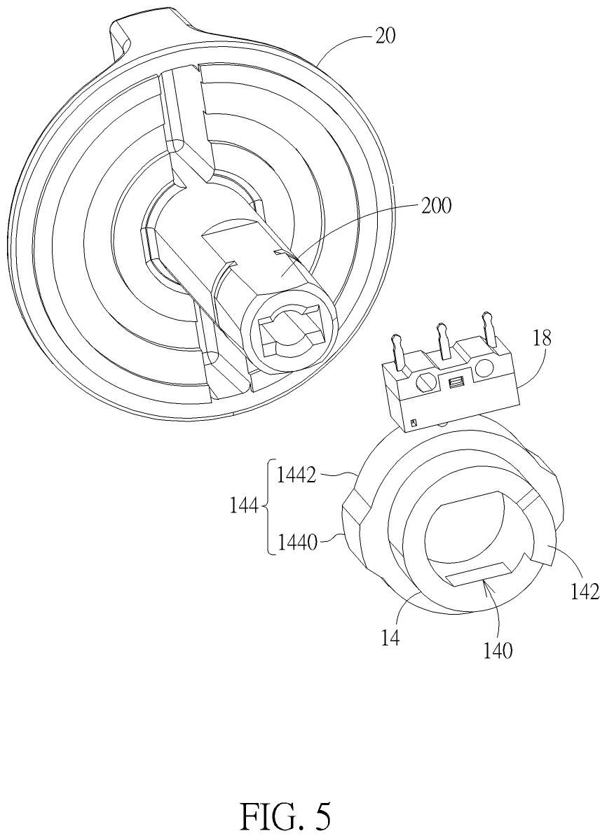

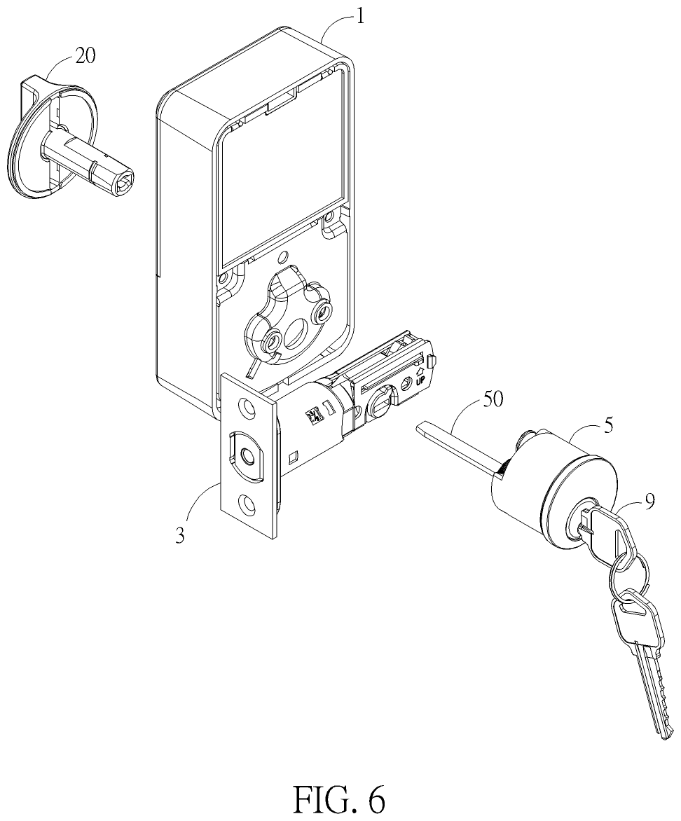

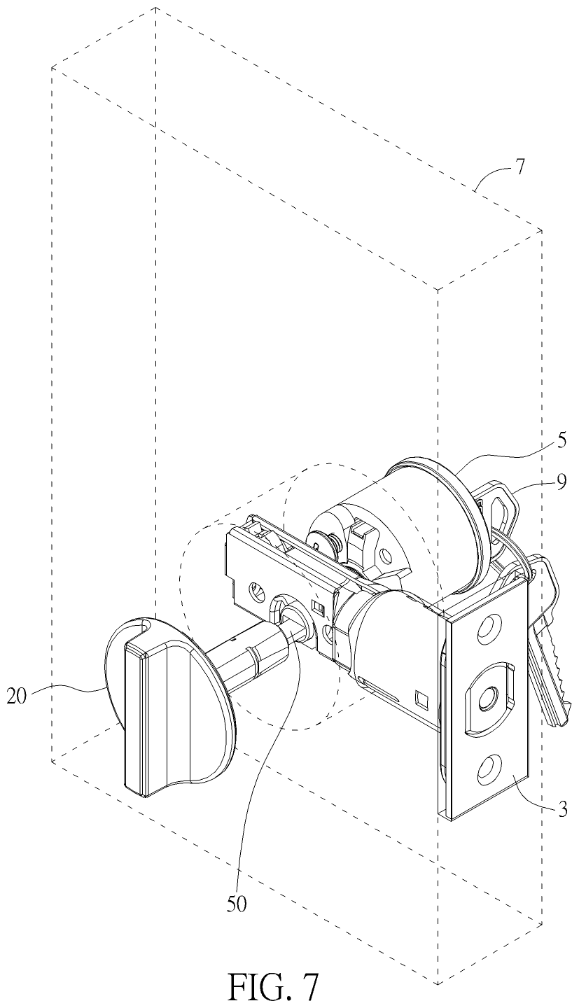

Referring to FIGS. 1 to 7, FIG. 1 is a perspective view illustrating an electronic lock 1 according to an embodiment of the invention, FIG. 2 is a perspective view illustrating the inside of the electronic lock 1, FIG. 3 is a perspective view illustrating a motor 10 and a transmission gear 12, FIG. 4 is a perspective view illustrating the transmission gear 12 and a first sensor 16, FIG. 5 is a perspective view illustrating a transmission shaft 14, a second sensor 18 and a turnpiece 20, FIG. 6 is an exploded view illustrating the electronic lock 1, a bolt 3 and a lock cylinder 5, and FIG. 7 is a perspective view illustrating a door 7 equipped with the turnpiece 20, the bolt 3 and the lock cylinder 5.

As shown in FIGS. 1 to 5, the electronic lock 1 comprises a motor 10, a transmission gear 12, a transmission shaft 14, a first sensor 16, a second sensor 18 and a turnpiece 20. In this embodiment, the electronic lock 1 may be an inner assembly installed on an inner side of a door 7 (as shown in FIG. 7). In general, the electronic lock 1 may be used in conjunction with an outer assembly installed on an outer side of the door 7 and a bolt 3 installed in the door 7 (as shown in FIGS. 6 and 7), wherein the outer assembly comprises a lock cylinder 5. Thus, the electronic lock 1 may be automatically controlled by the motor 10 or manually controlled by the turnpiece 20 to retract or extend the bolt 3. Furthermore, a transmission rod 50 of the lock cylinder 5 passes through the bolt 3 and is connected to the turnpiece 20. Thus, a user may insert a key 9 into the lock cylinder 5 and turn the key 9. At this time, the transmission rod 50 of the lock cylinder 5 will drive the turnpiece 20 to rotate and drive the bolt 3 to move, so as to manually control the bolt 3 to retract or extend. Similarly, when the user turns the turnpiece 20, the turnpiece 20 will drive the transmission rod 50 of the lock cylinder 5 to rotate, so as to drive the bolt 3 to move.

The transmission gear 12 is connected to the motor 10. As shown in FIG. 3, the motor 10 may have a driving gear 100 and the transmission gear 12 may mesh with the driving gear 100, such that the transmission gear 12 is connected to the motor 10. Thus, the motor 10 may drive the transmission gear 12 to rotate through the driving gear 100. As shown in FIG. 4, the transmission gear 12 may have an accommodating hole 120, a first transmission structure 122 and a first geometric structure 124, wherein the first transmission structure 122 may be located in the accommodating hole 120, and the first geometric structure 124 may be located at an outer periphery of the transmission gear 12. In other embodiments, the first transmission structure 122 may also be a protrusion or a recess formed on one side of the transmission gear 12 according to practical applications. Furthermore, in other embodiments, the first geometric structure 124 may also be disposed on a side of the transmission gear 12 according to practical applications.

The first sensor 16 is disposed with respect to the first geometric structure 124, such that the first sensor 16 may sense a position of the transmission gear 12 through the first geometric structure 124. In this embodiment, the first geometric structure 124 may comprise a plurality of first characteristic portions 1240 and a plurality of first relative portions 1242. As shown in FIG. 4, the first geometric structure 124 may comprise four first characteristic portions 1240 and four first relative portions 1242. In this embodiment, the first characteristic portion 1240 is a convex portion and the first relative portion 1242 is a concave portion, but the invention is not so limited. In other embodiments, the concave and convex configurations of the first characteristic portion 1240 and the first relative portion 1242 may be interchanged. In other words, one of the first characteristic portion 1240 and the first relative portion 1242 may be a convex portion, the other one of the first characteristic portion 1240 and the first relative portion 1242 may be a concave portion, and it depends on practical applications. It should be noted that the number and position of the first characteristic portions 1240 and the first relative portions 1242 may be determined according to practical applications, so the invention is not limited to the embodiment shown in the figure.

In this embodiment, the first sensor 16 may be a contact sensor or a non-contact sensor (e.g. light sensor, magnetic sensor, and so on). When one of the first characteristic portions 1240 moves to a position corresponding to the first sensor 16, the first sensor 16 may output a first status signal; and, when one of the first relative portions 1242 moves to a position corresponding to the first sensor 16, the first sensor 16 may output a second status signal. For further explanation, when the first characteristic portion 1240 moves to the position corresponding to the first sensor 16, the first sensor 16 will be triggered by the first characteristic portion 1240 and output an ON signal as the first status signal; and, when the first relative portion 1242 moves to the position corresponding to the first sensor 16, the first sensor 16 will not be triggered by the first relative portions 1242 and output an OFF signal as the second status signal.

As shown in FIG. 5, the transmission shaft 14 has a non-circular hole 140, a second transmission structure 142 and a second geometric structure 144. The end of the transmission shaft 14 with the second transmission structure 142 may be inserted into the accommodating hole 120 of the transmission gear 12 (as shown in FIG. 4), such that the transmission shaft 14 is rotatably connected to the transmission gear 12, and the second transmission structure 142 is located between two side walls 122a, 122b of the first transmission structure 122. Accordingly, when the transmission gear 12 rotates, the transmission gear 12 may drive the transmission shaft 14 to rotate through the first transmission structure 122 and the second transmission structure 142. Furthermore, the turnpiece 20 has a non-circular shaft portion 200. The non-circular shaft portion 200 of the turnpiece 20 may be inserted into the non-circular hole 140 of the transmission shaft 14, such that the turnpiece 20 may drive the transmission shaft 14 to rotate. The shape of the on-circular hole 140 corresponds to the shape of the non-circular shaft portion 200. The non-circular hole may be rectangular, oval, square or other non-circular shapes.

In this embodiment, the first transmission structure 122 and the second transmission structure 142 may be arc-shaped, but the invention is not so limited. In other embodiments, the second transmission structure 142 may be a protrusion and the first transmission structure 122 may comprise two protrusions providing the two side walls 122a, 122b.

The second geometric structure 144 may be located at an outer periphery of the transmission shaft 14, and the second sensor 18 is disposed with respect to the second geometric structure 144, such that the second sensor 18 may sense a position of the transmission shaft 14 through the second geometric structure 144. In other embodiments, the second geometric structure 144 may also be disposed on a side of the transmission shaft 14 according to practical applications. In this embodiment, the second geometric structure 144 may comprise a plurality of second characteristic portions 1440 and a plurality of second relative portions 1442. As shown in FIG. 5, the second geometric structure 144 may comprise two second characteristic portions 1440 and two second relative portions 1442. In this embodiment, the second characteristic portion 1440 is a convex portion and the second relative portion 1442 is a concave portion, but the invention is not so limited. In other embodiments, the concave and convex configurations of the second characteristic portion 1440 and the second relative portion 1442 may be interchanged. In other words, one of the second characteristic portion 1440 and the second relative portion 1442 may be a convex portion, the other one of the second characteristic portion 1440 and the second relative portion 1442 may be a concave portion, and it depends on practical applications. It should be noted that the number and position of the second characteristic portions 1440 and the second relative portions 1442 may be determined according to practical applications, so the invention is not limited to the embodiment shown in the figure.

In this embodiment, since the four first characteristic portions 1240 and the four first relative portions 1242 are symmetrically arranged, and the two second characteristic portions 1440 and the two second relative portions 1442 are symmetrically arranged, the electronic lock 1 may be installed on a door that opens to the right or installed on a door that opens to the left. However, the invention is not limited to symmetrical arrangement.

In this embodiment, the second sensor 18 may be a contact sensor or a non-contact sensor (e.g. light sensor, magnetic sensor, and so on). When one of the second characteristic portions 1440 moves to a position corresponding to the second sensor 18, the second sensor 18 may output the first status signal; and, when one of the second relative portions 1442 moves to a position corresponding to the second sensor 18, the second sensor 18 may output the second status signal. For further explanation, when the second characteristic portion 1440 moves to the position corresponding to the second sensor 18, the second sensor 18 will be triggered by the second characteristic portion 1440 and output an ON signal as the first status signal; and, when the second relative portion 1442 moves to the position corresponding to the second sensor 18, the second sensor 18 will not be triggered by the second relative portions 1442 and output an OFF signal as the second status signal.

Accordingly, the motor 10 may drive the transmission gear 12 to rotate according to sensing results of the first sensor 16 and the second sensor 18, so as to execute an unlock command or a lock command.

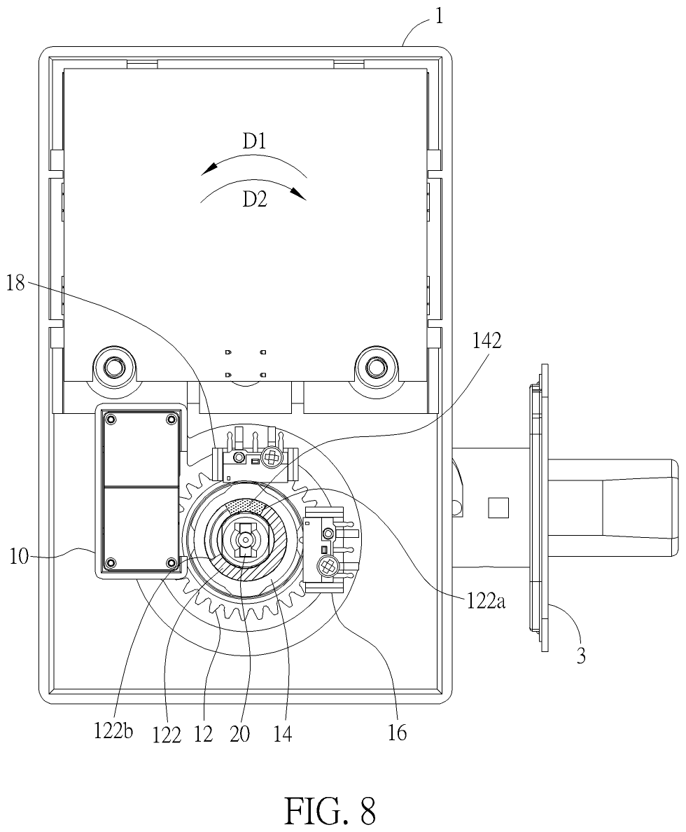

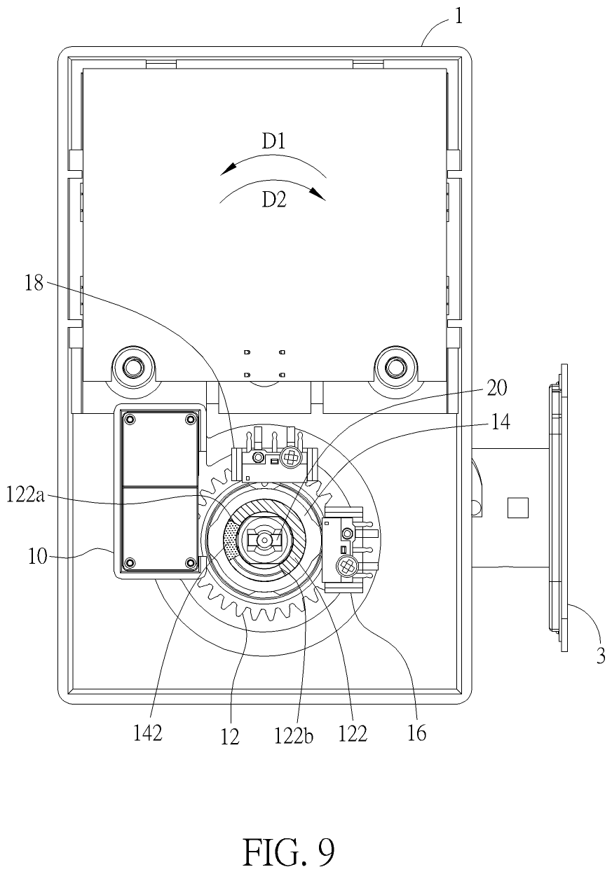

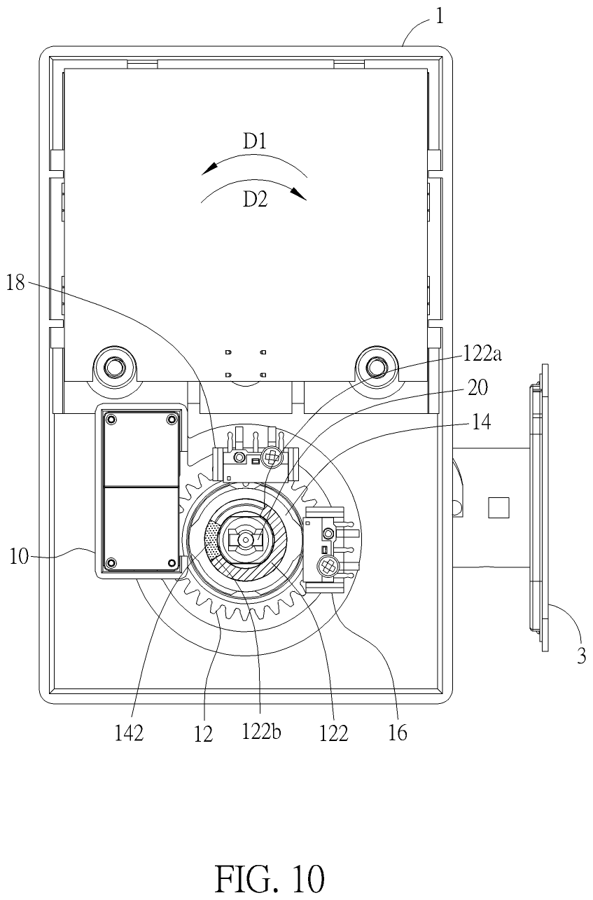

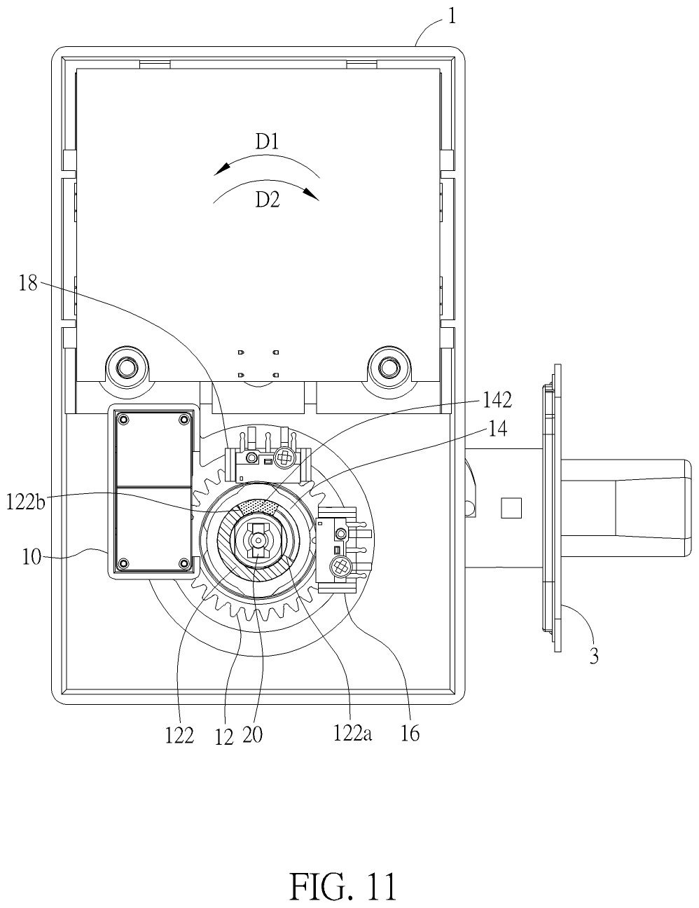

Referring to FIGS. 8 to 11, FIG. 8 is a front view illustrating the electronic lock 1 being locked, FIG. 9 is a front view illustrating the electronic lock 1 being unlocked, FIG. 10 is another front view illustrating the electronic lock 1 being unlocked, and FIG. 11 is another front view illustrating the electronic lock 1 being locked. In the following, the driving method of the electronic lock 1 of the invention will be depicted in accordance with FIGS. 8 to 11, and the second characteristic portion 1440 and the second relative portion 1442 of the transmission shaft 14 are referred to FIG. 5.

As shown in FIG. 8, when the electronic lock 1 is locked, the second sensor 18 is triggered by the second characteristic portion 1440 of the transmission shaft 14 and outputs the first status signal (ON). In other words, when the second sensor 18 outputs the first status signal (ON), the electronic lock 1 is locked. At this time, the second transmission structure 142 abuts against the side wall 122a of the first transmission structure 122, and the second transmission structure 142 is separated from the side wall 122b of the first transmission structure 122. When the motor 10 receives an unlock command, the motor 10 drives the transmission gear 12 to rotate along a first direction D1, and the transmission gear 12 drives the transmission shaft 14 to rotate along the first direction D1, such that the electronic lock 1 is unlocked, as shown in FIG. 9. When the transmission gear 12 rotates from the position shown in FIG. 8 to the position shown in FIG. 9, the first sensor 16 corresponds to the first relative portion 1242, the first characteristic portion 1240 and the first relative portion 1242 in sequence, and outputs the second status signal (OFF), the first status signal (ON) and the second status signal (OFF) in sequence. At this time, the electronic lock 1 is unlocked.

When the first sensor 16 outputs the second status signal (OFF), the first status signal (ON) and the second status signal (OFF) in sequence, the motor 10 will stop first and then drives the transmission gear 12 to rotate along a second direction D2 to the position shown in FIG. 10, wherein the first direction D1 is opposite to the second direction D2. At this time, the second transmission structure 142 abuts against the side wall 122b of the first transmission structure 122, and the second transmission structure 142 is separated from the side wall 122a of the first transmission structure 122. When the transmission gear 12 rotates from the position shown in FIG. 9 to the position shown in FIG. 10, the first sensor 16 corresponds to the first relative portion 1242, the first characteristic portion 1240 and the first relative portion 1242 in sequence, and outputs the second status signal (OFF), the first status signal (ON) and the second status signal (OFF) in sequence. Thus, when the first sensor 16 outputs the second status signal (OFF), the first status signal (ON) and the second status signal (OFF) in sequence, the motor 10 will stop. Accordingly, after the electronic lock 1 is unlocked, the motor 10 will further drive the transmission gear 12 to rotate from the position shown in FIG. 9 to the position shown in FIG. 10.

As shown in FIG. 10, when the electronic lock 1 is unlocked, the second sensor 18 is not triggered by the second relative portion 1442 of the transmission shaft 14 and outputs the second status signal (OFF). In other words, when the second sensor 18 outputs the second status signal (OFF), the electronic lock 1 is unlocked. At this time, the second transmission structure 142 abuts against the side wall 122b of the first transmission structure 122, and the second transmission structure 142 is separated from the side wall 122a of the first transmission structure 122. When the motor 10 receives a lock command, the motor 10 drives the transmission gear 12 to rotate along the second direction D2, and the transmission gear 12 drives the transmission shaft 14 to rotate along the second direction D2, such that the electronic lock 1 is locked, as shown in FIG. 11. When the transmission gear 12 rotates from the position shown in FIG. 10 to the position shown in FIG. 11, the second sensor 18 corresponds to the second relative portion 1442 and the second characteristic portion 1440 in sequence, and outputs the second status signal (OFF) and the first status signal (ON) in sequence. At this time, the electronic lock 1 is locked.

When the second sensor 18 outputs the second status signal (OFF) and the first status signal (ON) in sequence, the motor 10 will stop first and then drives the transmission gear 12 to rotate along the first direction D1 to the position shown in FIG. 8. At this time, the second transmission structure 142 abuts against the side wall 122a of the first transmission structure 122, and the second transmission structure 142 is separated from the side wall 122b of the first transmission structure 122. When the transmission gear 12 rotates from the position shown in FIG. 11 to the position shown in FIG. 8, the first sensor 16 corresponds to the first relative portion 1242, the first characteristic portion 1240 and the first relative portion 1242 in sequence, and outputs the second status signal (OFF), the first status signal (ON) and the second status signal (OFF) in sequence. Thus, when the first sensor 16 outputs the second status signal (OFF), the first status signal (ON) and the second status signal (OFF) in sequence, the motor 10 will stop. Accordingly, after the electronic lock 1 is locked, the motor 10 will further drive the transmission gear 12 to rotate from the position shown in FIG. 11 to the position shown in FIG. 8.

During the aforesaid process of locking the electronic lock 1, when the transmission gear 12 rotates from the position shown in FIG. 10 to the position shown in FIG. 11, the first sensor may also be used to control the motor 10. For further explanation, when the transmission gear 12 rotates from the position shown in FIG. 10 to the position shown in FIG. 11, the first sensor 16 corresponds to the first relative portion 1242, the first characteristic portion 1240 and the first relative portion 1242 in sequence, and outputs the second status signal (OFF), the first status signal (ON) and the second status signal (OFF) in sequence. Thus, when the first sensor 16 outputs the second status signal (OFF), the first status signal (ON) and the second status signal (OFF) in sequence, the motor 10 may stop first and then drives the transmission gear 12 to rotate along the first direction to the position shown in FIG. 8.

As shown in FIGS. 8 and 10, when the electronic lock 1 is locked or unlocked, the second transmission structure 142 abuts against one of the two side walls 122a, 122b of the first transmission structure 122 and is separated from the other one of the two side walls 122a, 122b of the first transmission structure 122. At this time, a user may turn the turnpiece 20 to manually lock or unlock the electronic lock 1.

As shown in FIG. 8, when the electronic lock 1 is locked and the turnpiece 20 drives the transmission shaft 14 to rotate along the first direction D1, the electronic lock 1 is unlocked (as shown in FIG. 10). Since the second transmission structure 142 is separated from the side wall 122b of the first transmission structure 122, the motor 10 will not be driven by the turnpiece 20 through the transmission shaft 14 and the transmission gear 12. When the transmission shaft 14 rotates from the position shown in FIG. 8 to the position shown in FIG. 10, the second sensor 18 corresponds to the second characteristic portion 1440 and the second relative portion 1442 in sequence, and outputs the first status signal (ON) and the second status signal (OFF) in sequence.

As shown in FIG. 10, when the electronic lock 1 is unlocked and the turnpiece 20 drives the transmission shaft 14 to rotate along the second direction D2, the electronic lock 1 is locked (as shown in FIG. 8). Since the second transmission structure 142 is separated from the side wall 122a of the first transmission structure 122, the motor 10 will not be driven by the turnpiece 20 through the transmission shaft 14 and the transmission gear 12. When the transmission shaft 14 rotates from the position shown in FIG. 10 to the position shown in FIG. 8, the second sensor 18 corresponds to the second relative portion 1442 and the second characteristic portion 1440 in sequence, and outputs the second status signal (OFF) and the first status signal (ON) in sequence.

It should be noted that, in another embodiment, the aforesaid first status signal may also be an OFF signal and the aforesaid second status signal may also be an ON signal according to practical applications.

As mentioned in the above, the motor of the electronic lock drives the transmission gear to rotate according to the sensing results of the first sensor and the second sensor. After the motor drives the transmission gear to rotate to unlock or lock the electronic lock, the motor will further drive the transmission gear to rotate in the reverse direction. When a user turns a turnpiece to unlock or lock the electronic lock, the motor will not be driven by the turnpiece. Accordingly, the stability of a power supply and the operating feel of the user will not be affected.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic lock comprising:
a motor;
a transmission gear connected to the motor, the transmission gear having a first transmission structure and a first geometric structure;
a transmission shaft rotatably connected to the transmission gear, the transmission shaft having a second transmission structure and a second geometric structure;
a first sensor disposed with respect to the first geometric structure, the first sensor sensing a position of the transmission gear through the first geometric structure; and
a second sensor disposed with respect to the second geometric structure, the second sensor sensing a position of the transmission shaft through the second geometric structure;
wherein the motor drives the transmission gear to rotate according to sensing results of the first sensor and the second sensor, and the transmission gear drives the transmission shaft to rotate through the first transmission structure and the second transmission structure.

2. The electronic lock of claim 1, wherein the first geometric structure comprises a plurality of first characteristic portions and a plurality of first relative portions, and the second geometric structure comprises a plurality of second characteristic portions and a plurality of second relative portions; wherein, when one of the plurality of first characteristic portions moves to a position corresponding to the first sensor, the first sensor outputs a first status signal; wherein, when one of the plurality of first relative portions moves to a position corresponding to the first sensor, the first sensor outputs a second status signal; wherein, when one of the plurality of second characteristic portions moves to a position corresponding to the second sensor, the second sensor outputs the first status signal; wherein, when one of the plurality of second relative portions moves to a position corresponding to the second sensor, the second sensor outputs the second status signal.

3. The electronic lock of claim 2, wherein, when the second sensor outputs the first status signal, the electronic lock is locked; wherein, when the motor receives an unlock command, the motor drives the transmission gear to rotate along a first direction, and the transmission gear drives the transmission shaft to rotate along the first direction, such that the electronic lock is unlocked; wherein, when the first sensor outputs the second status signal, the first status signal and the second status signal in sequence, the motor stops and then drives the transmission gear to rotate along a second direction; wherein, when the first sensor outputs the second status signal, the first status signal and the second status signal in sequence, the motor stops; wherein the first direction is opposite to the second direction.

4. The electronic lock of claim 2, wherein, when the second sensor outputs the second status signal, the electronic lock is unlocked; wherein, when the motor receives a lock command, the motor drives the transmission gear to rotate along a second direction, and the transmission gear drives the transmission shaft to rotate along the second direction, such that the electronic lock is locked; wherein, when the second sensor outputs the second status signal and the first status signal in sequence, the motor stops and then drives the transmission gear to rotate along a first direction; wherein, when the first sensor outputs the second status signal, the first status signal and the second status signal in sequence, the motor stops; wherein the first direction is opposite to the second direction.

5. The electronic lock of claim 2, wherein, when the second sensor outputs the second status signal, the electronic lock is unlocked; wherein, when the motor receives a lock command, the motor drives the transmission gear to rotate along a second direction, and the transmission gear drives the transmission shaft to rotate along the second direction, such that the electronic lock is locked; wherein, when the first sensor outputs the second status signal, the first status signal and the second status signal in sequence, the motor stops and then drives the transmission gear to rotate along a first direction; wherein, when the first sensor outputs the second status signal, the first status signal and the second status signal in sequence, the motor stops; wherein the first direction is opposite to the second direction.

6. The electronic lock of claim 2, wherein one of the first characteristic portion and the first relative portion is a convex portion, the other one of the first characteristic portion and the first relative portion is a concave portion, one of the second characteristic portion and the second relative portion is a convex portion, and the other one of the second characteristic portion and the second relative portion is a concave portion.

7. The electronic lock of claim 1, wherein, when the electronic lock is locked or unlocked, the second transmission structure abuts against one of two side walls of the first transmission structure and is separated from the other one of the two side walls of the first transmission structure.

8. The electronic lock of claim 1, further comprising a turnpiece, wherein the turnpiece has a non-circular shaft portion, the transmission shaft has a non-circular hole, and the non-circular shaft portion is inserted into the non-circular hole.

9. The electronic lock of claim 8, wherein, when the electronic lock is unlocked and the turnpiece drives the transmission shaft to rotate, the electronic lock is locked and the second sensor outputs the second status signal and the first status signal in sequence; wherein, when the electronic lock is locked and the turnpiece drives the transmission shaft to rotate, the electronic lock is unlocked and the second sensor outputs the first status signal and the second status signal in sequence.

10. The electronic lock of claim 1, wherein the first sensor and the second sensor are contact sensors.

11. A driving method of an electronic lock, the electronic lock comprising a motor, a transmission gear, a transmission shaft, a first sensor and a second sensor, the transmission gear having a first transmission structure and a first geometric structure, the transmission shaft having a second transmission structure and a second geometric structure, the first sensor being disposed with respect to the first geometric structure, the second sensor being disposed with respect to the second geometric structure, the driving method of the electronic lock comprising steps of:
the first sensor sensing a position of the transmission gear through the first geometric structure, and the second sensor sensing a position of the transmission shaft through the second geometric structure;
the motor driving the transmission gear to rotate according to sensing results of the first sensor and the second sensor; and
the transmission gear driving the transmission shaft to rotate through the first transmission structure and the second transmission structure, so as to lock or unlock the electronic lock.

12. The driving method of the electronic lock of claim 11, wherein the first geometric structure comprises a plurality of first characteristic portions and a plurality of first relative portions, the second geometric structure comprises a plurality of second characteristic portions and a plurality of second relative portions, the driving method of the electronic lock further comprises steps of:
when one of the plurality of first characteristic portions moves to a position corresponding to the first sensor, the first sensor outputting a first status signal;
when one of the plurality of first relative portions moves to a position corresponding to the first sensor, the first sensor outputting a second status signal;
when one of the plurality of second characteristic portions moves to a position corresponding to the second sensor, the second sensor outputting the first status signal; and
when one of the plurality of second relative portions moves to a position corresponding to the second sensor, the second sensor outputting the second status signal.

13. The driving method of the electronic lock of claim 12, further comprising steps of:
when the second sensor outputs the first status signal, the electronic lock being locked;
when the motor receives an unlock command, the motor driving the transmission gear to rotate along a first direction, and the transmission gear driving the transmission shaft to rotate along the first direction, such that the electronic lock is unlocked;
when the first sensor outputs the second status signal, the first status signal and the second status signal in sequence, the motor stopping and then driving the transmission gear to rotate along a second direction, wherein the first direction is opposite to the second direction; and
when the first sensor outputs the second status signal, the first status signal and the second status signal in sequence, the motor stopping.

14. The driving method of the electronic lock of claim 12, further comprising steps of:
when the second sensor outputs the second status signal, the electronic lock being unlocked;
when the motor receives a lock command, the motor driving the transmission gear to rotate along a second direction, and the transmission gear driving the transmission shaft to rotate along the second direction, such that the electronic lock is locked;
when the second sensor outputs the second status signal and the first status signal in sequence, the motor stopping and then driving the transmission gear to rotate along a first direction, wherein the first direction is opposite to the second direction; and
when the first sensor outputs the second status signal, the first status signal and the second status signal in sequence, the motor stopping.

15. The driving method of the electronic lock of claim 12, further comprising steps of:
when the second sensor outputs the second status signal, the electronic lock being unlocked;
when the motor receives a lock command, the motor driving the transmission gear to rotate along a second direction, and the transmission gear driving the transmission shaft to rotate along the second direction, such that the electronic lock is locked;
when the first sensor outputs the second status signal, the first status signal and the second status signal in sequence, the motor stopping and then driving the transmission gear to rotate along a first direction, wherein the first direction is opposite to the second direction; and
when the first sensor outputs the second status signal, the first status signal and the second status signal in sequence, the motor stopping.

16. The driving method of the electronic lock of claim 12, wherein one of the first characteristic portion and the first relative portion is a convex portion, the other one of the first characteristic portion and the first relative portion is a concave portion, one of the second characteristic portion and the second relative portion is a convex portion, and the other one of the second characteristic portion and the second relative portion is a concave portion.

17. The driving method of the electronic lock of claim 11, wherein, when the electronic lock is locked or unlocked, the second transmission structure abuts against one of two side walls of the first transmission structure and is separated from the other one of the two side walls of the first transmission structure.

18. The driving method of the electronic lock of claim 11, wherein the electronic lock further comprises a turnpiece, the turnpiece has a non-circular shaft portion, the transmission shaft has a non-circular hole, and the non-circular shaft portion is inserted into the non-circular hole.

19. The driving method of the electronic lock of claim 18, wherein, when the electronic lock is unlocked and the turnpiece drives the transmission shaft to rotate, the electronic lock is locked and the second sensor outputs the second status signal and the first status signal in sequence; wherein, when the electronic lock is locked and the turnpiece drives the transmission shaft to rotate, the electronic lock is unlocked and the second sensor outputs the first status signal and the second status signal in sequence.

20. The driving method of the electronic lock of claim 11, wherein the first sensor and the second sensor are contact sensors.
